(19) United States
(12) Patent Application Publication
(10) Pub. No.: US 2026/0016118 A1
(43) Pub. Date: Jan. 15, 2026

(54) MOBILE ELECTRONIC DEVICE STAND

(71) Applicant: William C. LAIDLAW, Bellevue, WA (US)

(72) Inventor: William C. LAIDLAW, Bellevue, WA (US)

(21) Appl. No.: 19/202,707

(22) Filed: May 8, 2025

Related U.S. Application Data
(60) Provisional application No. 63/670,467, filed on Jul. 12, 2024.

(51) Int. Cl. F16M 11/20

(52) U.S. Cl. CPC F16M 11/20; F16M 2200/08

(57) ABSTRACT

An electronic device stand, comprises (i) a base configured for placement on a substantially horizontal surface; and (ii) a plurality of electronic device holders connected to the base, each of the plurality of electronic device holders being configured to receive and support a respective electronic device such that a respective normal vector of a respective display of the respective electronic device is angularly offset from a surface normal vector of the substantially horizontal surface, wherein at least two of the plurality of electronic device holders are configured to support respective electronic devices such that respective electronic displays of the respective electronic devices face at least partially different azimuthal directions when held by the at least two of the plurality of electronic device holders.

### CROSS-REFERENCE TO RELATED APPLICATIONS

This application claims priority to and the benefit of U.S. Provisional Patent Application No. 63/670,467, filed on Jul. 12, 2024, and entitled MOBILE ELECTRONIC DEVICE STAND, the entirety of which is incorporated herein by reference for all purposes.

### BACKGROUND

Mobile electronic device use is ubiquitous across numerous industries, professions, and demographics worldwide. Individuals use mobile electronic devices, such as smartphones, for numerous purposes, including entertainment, personal and professional communications, tracking systems, location services, banking, shopping, photography, and many others. As the functionality afforded by mobile electronic devices has become integrated into daily life, Individuals have developed a strong need to stay connected in numerous locations, environments, and contexts. Accordingly, individuals typically keep mobile electronic devices on their person and often use such devices numerous times each day and in numerous places, such as airports, restaurants, at home, in the office, in waiting rooms, and in others.

The subject matter described herein is not limited to embodiments that operate only in environments such as those described above. Rather, this background is provided to illustrate some areas where some embodiments described herein may be practiced.

### BRIEF DESCRIPTION OF THE DRAWINGS

Reference will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1 illustrates an embodiment of a mobile electronic device stand that includes two holders facing different directions and a receptacle defining an opening.

FIG. 2 illustrates a side sectional view of a holder of a mobile electronic device stand.

FIG. 3 illustrates a top view of the mobile electronic device stand of FIG. 1.

FIG. 4 illustrates an embodiment of a mobile electronic device stand that includes four holders that surround a receptacle defining an opening.

FIG. 5 illustrates a top view of the mobile electronic device stand of FIG. 4.

FIG. 6 illustrates an embodiment of a mobile electronic device stand that includes two holders facing the same direction and a slot configured to retain an object.

FIG. 7 illustrates another view of the mobile electronic device stand of FIG. 6.

FIG. 8 illustrates a side view of the mobile electronic device stand of FIG. 6.

FIGS. 9 and 10 illustrate perspective views of an embodiment of a mobile electronic device stand configured to engage with a battery pack and/or an additional component

FIG. 11 illustrates a perspective view of a charging device for charging a battery pack for use in conjunction with a mobile electronic device stand.

FIGS. 12 through 32 illustrate various views of various embodiments of mobile electronic device stands.

### DETAILED DESCRIPTION

The disclosed subject matter relates to mobile electronic device stands for mobile electronic devices.

As noted above, devices are used daily in numerous settings and industries across the globe. Often, when a person uses a mobile electronic device in a public setting, such as a restaurant or an airport, the person sets their device on a flat surface, such as a table, and leans over the device to interact therewith. Using a mobile electronic device in such a manner is associated with various disadvantages and/or discomforts. For instance, a device flat on a horizontal surface can be difficult to use or view, and maintaining a leaning position over the device can cause bodily discomfort. Furthermore, a horizontally oriented device can reflect overhead lighting, which can cause glare to obscure the content displayed on the device. Additionally, devices arranged flat on a table can cause inefficient use of space (e.g., occupying space for other items with which the user desires to interact).

Also, a device is susceptible to damage while lying flat on a surface (whether the device is being actively used or not). For example, devices may be knocked from the table or have heavy objects set or fall on top of them, causing cracks or other damage. As another example, devices are susceptible to spills that can damage the electronic componentry of the device.

Many users heavily rely on interconnections achieved by their mobile electronic devices, and missing notifications or correspondences (e.g., business emails, family messages) can have undesirable consequences. Accordingly, to stay connected, users continue to use their mobile electronic devices in public settings (e.g., by laying them flat on public tables), despite the aforementioned challenges and/or hazards associated therewith.

The disclosed subject matter pertains to mobile electronic device stands that can address at least some of the foregoing problems associated with mobile electronic device use in public settings (e.g., at public tables). A mobile electronic device stand, as disclosed herein, can include a base and a plurality of electronic device holders that are each able to retain and support an electronic device at an at least partially upright angle. In this way, when multiple users share a common public table (e.g., in a restaurant, airport, or other setting), each user can place their mobile electronic device on a separate holder of a single, space-efficient stand.

An electronic device stand configured to hold multiple devices can incorporate other features that further improve its utility. For instance, an electronic device stand can include a receptacle that is able to receive a table centerpiece (e.g., a candle, flowers, a vase, and/or others). The receptacle can be centrally located with the electronic device holders positioned radially about the receptacle. Such a configuration can contribute to a desirable aesthetic and can enable users to conveniently access the various electronic device holders from different angles (e.g., from different seating positions around a table). Another example feature that can be implemented on an electronic device stand is a menu holder or slot, which can be configured to hold a menu or other document or object for review by individuals sitting at the public table. Y et another example feature that can be implemented is an interactive display, which can facilitate food ordering, payment, and/or other functionality for individuals sitting at a public table. In some instances, an electronic device stand can be configured with one or more wireless charging coils positioned on one or more of the electronic device holders.

An electronic device stand, as disclosed herein, can enable efficient utilization of space on public tables by providing a unitary device on which multiple users can place their mobile electronic devices. For instance, by securing devices with an at least partially vertical orientation, the surface area on the table occupied by each device can be reduced. Further efficiencies can be realized by implementing additional features, such as a centerpiece holder, menu holder, or interactive display, on the electronic device stand (rather than having separate objects on the table for performing these functions). Furthermore, because an electronic device stand can retain the devices of users above the surface of the table, the users' devices can be protected from spillage, impacts from other objects, and other potential hazards. Also, with user devices at least partially vertically oriented when held by the electronic device stand, the amount of ambient light glare perceived by users when operating their devices can be reduced, and users may interact with their devices from a more comfortable body position (e.g., without significant leaning). An additional benefit of the generally vertical orientation of devices held by an electronic device stand, as disclosed herein, is that the devices can be easily visible to their users, which can mitigate the risk of a user inadvertently leaving their device at the table when departing.

Having just described various features of the disclosed subject matter and various benefits achieved thereby, attention will now be directed to the Figures, which provide supporting illustrations related to the disclosed subject matter.

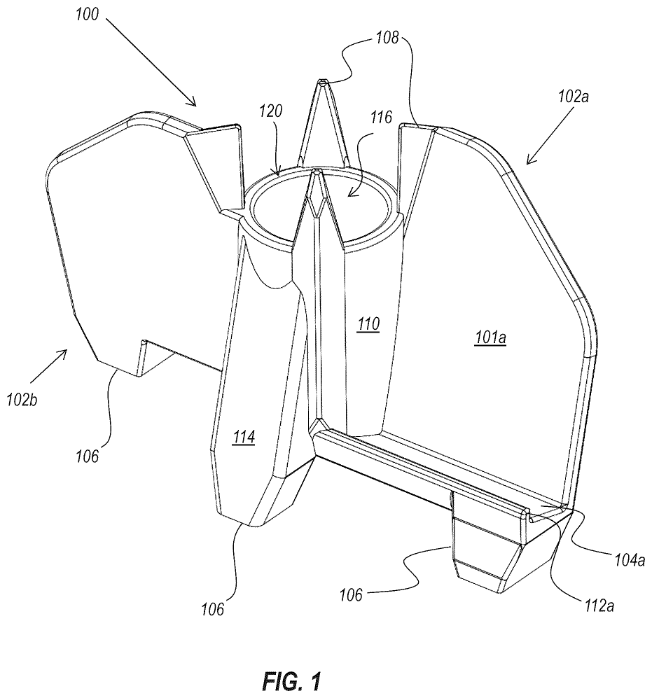

FIG. 1 illustrates an example mobile electronic device stand 100 (or simply “stand 100”) with holders configured to hold mobile electronic devices (e.g., smartphones, tablets, and/or others) such that the displays of the devices set on the holders face different directions. In the example shown in FIG. 1, stand 100 includes two holders 102a and 102b, which are connected to a base 106 and a receptacle 120 defining an opening 116. FIG. 1 further depicts the stand 100 as including a brace 114 that is also connected to the base 106. The brace 114 can provide additional stability when the stand 100 is placed on a substantially horizontal surface, such as a table, counter, or bar in a public setting (e.g., a restaurant, airport, library, waiting room, etc.). The example base 106 of the stand 100 illustrated in FIG. 1 comprises multiple, separate feet that extend from various components of the stand 100 (e.g., the holders 102a and 102b and the brace 114). One will appreciate that different base configurations may be implemented on a stand 100 as described herein. For instance, a base for a stand 100 may comprise a unitary or contiguous structure that extends from multiple components of the stand (e.g., both holders 102a and 102b, and/or the brace 114).

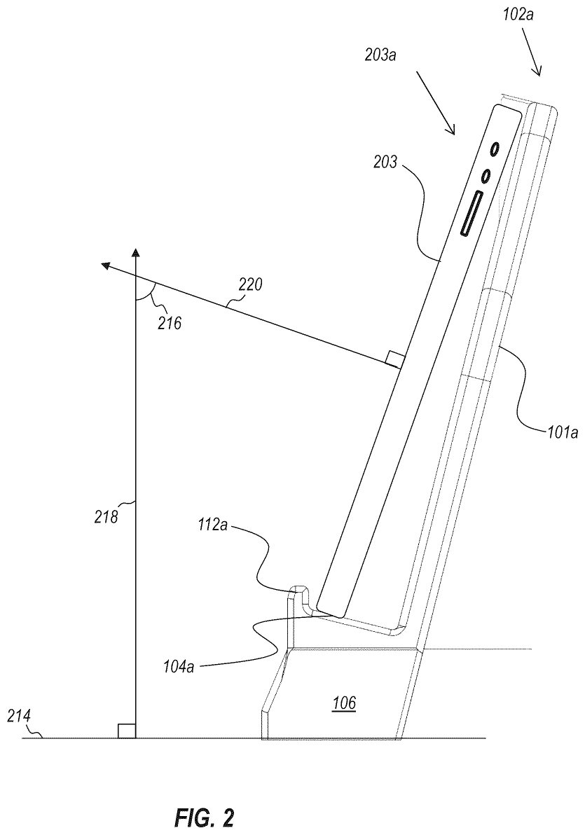

In the example shown in FIG. 1, holder 102a of the stand 100 is defined by a rear support 101a, a bottom support 104a, and a retention lip 112a, which together form a set of surfaces on which a mobile electronic device (e.g., a smartphone) can be placed for retention in a semi-upright position with a desired orientation. For instance, a rear surface of a smartphone (e.g., the surface opposite the screen) may be placed in contact with rear support 101a, whereas a bottom surface of the smartphone may be placed in contact with the bottom support 104a, while the retention lip 112a may prevent the bottom of the smartphone from tilting out of contact with the bottom support 104a (e.g., while the user positions the smartphone within the holder 102a). FIG. 2 provides an example depiction of a mobile electronic device positioned within holder 102a of stand 100.

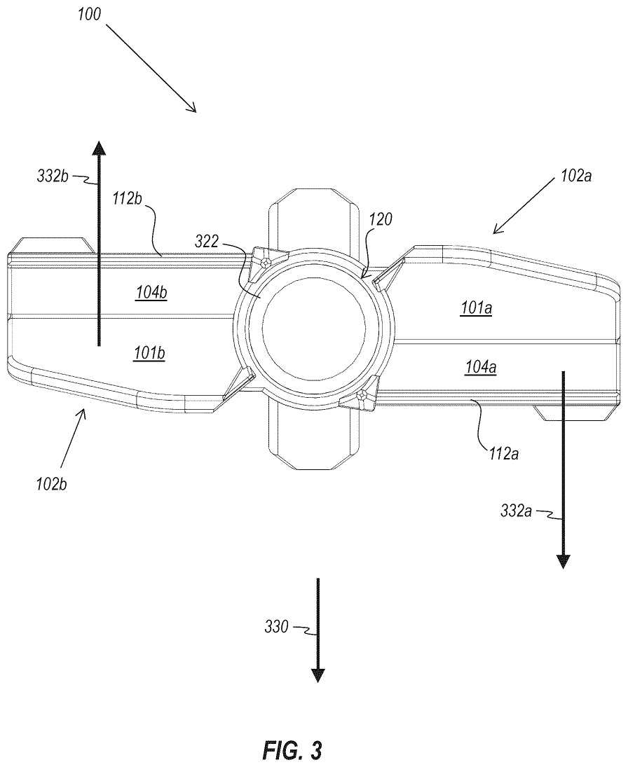

Holders 102a is also depicted in FIG. 1 as being further defined by the receptacle sidewall 110 of the receptacle 120 that defines the opening 116. The receptacle sidewall 110 can contribute to defining the resting position of mobile electronic devices placed within the holder 102a by functioning as a lateral stop for mobile electronic devices resting against the rear support 101a and the bottom support 104a. Holder 102b of the stand 100 also includes features similar to holder 102a, such as a rear support 101b, a bottom support 104b, and a retention lip 112b (see FIG. 3).

The rear supports 101a and 101b and the bottom support 104a and 104b of the holders 102a and 102b may be embodied in various ways. In some embodiments, rear supports 101a and 101b and bottom supports 104a and 104b are not implemented as continuous planar structures. For instance, the rear supports 101a and/or 101b and/or the bottom supports 104a and/or 104b may be characterized by a plurality of pegs, bars, or extensions that form a discontinuous wall capable of supporting a mobile electronic device. As another example, the rear supports 101a and/or 101b and/or the bottom supports 104a and/or 104b may be characterized by a grid structure, one or more curved surfaces, or another configuration.

The receptacle 120 that defines the opening 116 can be configured to hold objects other than mobile electronic devices. For instance, the receptacle 120 can be configured to hold objects that have a greater height, length, width, or overall shape than mobile electronic devices configured for placement within the holders 102a and/or 102b. For example, a flower vase with a bouquet of flowers placed therein may be inserted into the opening 116 of the receptacle 120, despite reaching far above the holders 102a and 102b and any mobile electronic device placed within the holders 102a and 102b. FIG. 1 illustrates an example in which the stand 100 includes extensions 108 that may be connected to or extend from the receptacle 120 to stabilize and direct the orientation of objects placed within the receptacle 120 (e.g., to mitigate obstruction of the holders 102a and/or 102b or respective devices placed therein).

FIG. 2 illustrates a sectional side view of the holder 102a of stand 100, providing an isolated representation thereof. FIG. 2 depicts an example in which a mobile electronic device 203a (or simply “device 203a”) is placed within and supported by the holder 102a. For instance, a rear surface or top edge of the device 203a is placed in contact with rear support 101a, and a bottom surface of the device 203a is placed in contact with the bottom support 104a. The retention lip 112a may prevent the bottom of the smartphone from tilting out of contact with the bottom support 104a. As noted above, although device 203a is depicted as a smartphone, a holder of a mobile electronic device stand as described herein can be configured to hold any type of mobile electronic device (e.g., different types of smartphones, tablets, graphing calculators, pagers, etc.).

In the example shown in FIG. 2, the holder 102a (or the stand 100 of which the holder 102a is a part) is placed on a substantially horizontal surface 214 (such as a table), with an element of the base 106 associated with the holder 102a placed in contact with the surface 214. When so positioned, a display 203 of the device 203a faces outward from the holder 102a with an inclination angle relative to a vertical axis. The inclination angle of the device display 203 when positioned within the holder 102a can be dependent on the inclination angle of the rear support 101a (with variations in the inclination angle being expected based on the specific resting position of the device 203a within the holder 102a). FIG. 2 conceptually depicts the inclination angle of the display 203 of the device 203a by including a surface normal vector 218 of the substantially horizontal surface 214 (e.g., the table), which represents a vertical axis. FIG. 2 also includes a normal vector 220 of the display 203 of the device 203a, showing the inclination angle 216 or angular offset of the display 203 relative to the surface normal vector 218.

In some implementations, the rear support 101a of the holder 102a may be adjustable so that a desired inclination angle for viewing and/or interacting with the display 203 of the device 203a may be achieved.

FIG. 3 illustrates a top view of the stand 100 of FIG. 1, which, as described above, includes two holders 102a and 102b arranged on opposing side of a receptacle 120. In the example shown in FIG. 3, the holders 102a and 102b are positioned about the receptacle 120 such that the rear supports 101a and 101b (or the displays of devices when positioned thereon) face different azimuthal directions. As used herein, “azimuthal direction” refers to the direction that an object faces relative to a reference direction (around a vertical axis), which can be represented as an azimuth angle measured clockwise from the reference direction. FIG. 3 illustrates an example reference direction 330, an azimuthal direction 332a for holder 102a (with an azimuth angle of) 0°, and an azimuthal direction 332b for holder 102b (with an azimuth angle of) 180°. The configuration of the stand 100 shown in FIG. 3 may be beneficial for device users on opposite sides of a table, for instance.

One will appreciate, in view of the present disclosure, that the azimuthal directions of different holders of a mobile electronic device stand as described herein can be varied for different implementation contexts. For example, for table arrangements where two users sit on the same side of a table, a mobile electronic device support may implement two holders that both face the same azimuthal direction. As another example, for table arrangements where two users sit at right angles to one another, a mobile electronic device support may implement two holders with azimuthal directions that are offset by 90°.

In the example shown in FIG. 3, the receptacle 120 includes a retention lip 322, which may be used to support objects such as candles, vases, or others, placed within the receptacle 120. The retention lip 322 can enable the receptacle 120 to be easily cleaned while still providing support for objects. In some embodiments, retention lip 322 may have adjustable height inside the receptacle 120. As shown in FIGS. 1 and 3, the receptacle 120 has a cylindrical shape, but other shapes may be utilized within the scope of the present disclosure. Furthermore, in some instances, a mobile electronic device support as disclosed herein can omit a receptacle.

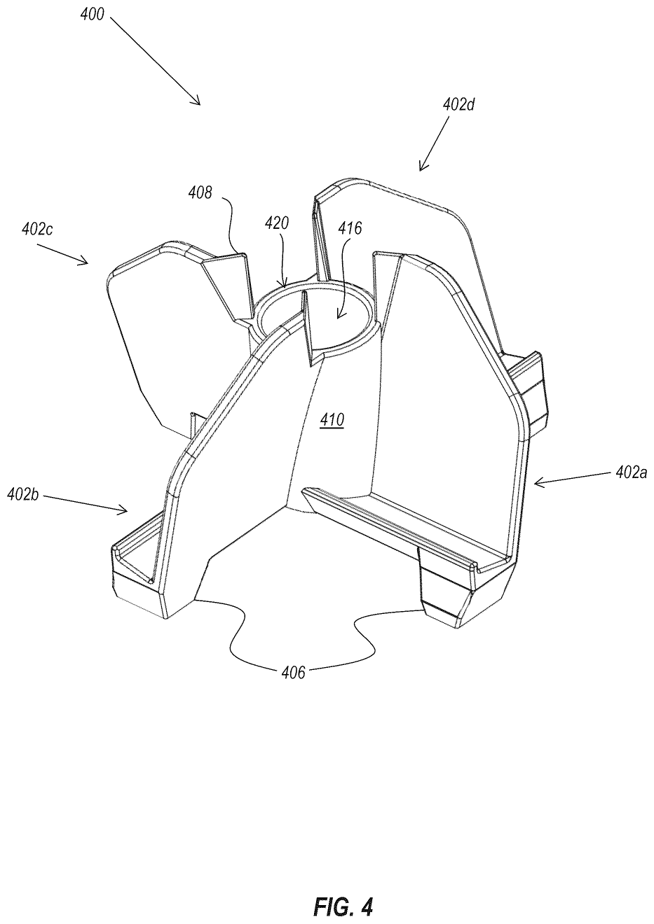

FIG. 4 illustrates an embodiment of a mobile electronic device stand 400 that includes four holders 402a, 402b, 402c, and 402d connected to a base 406 (including multiple feet). The holders 402a, 402b, 402c, and 402d are positioned radially around a receptacle 420 that defines an opening 416. A receptacle sidewall 410 of the receptacle 420 can act as a sidewall for the various holders 402a, 402b, 402c, and 402d. In the illustrated example, the holders 402a, 402b, 402c, and 402d include features similar to those of holders 102a and 102b of stand 100 (e.g., rear and bottom supports and a retention lip). The stand 400 is illustrated as including extensions 408 (e.g., extending from each holder 402a, 402b, 402c, and 402d). The extensions 408 can provide additional support for larger objects to be placed in the opening 416 of the receptacle 420, in addition to contributing to the aesthetic quality to the holder.

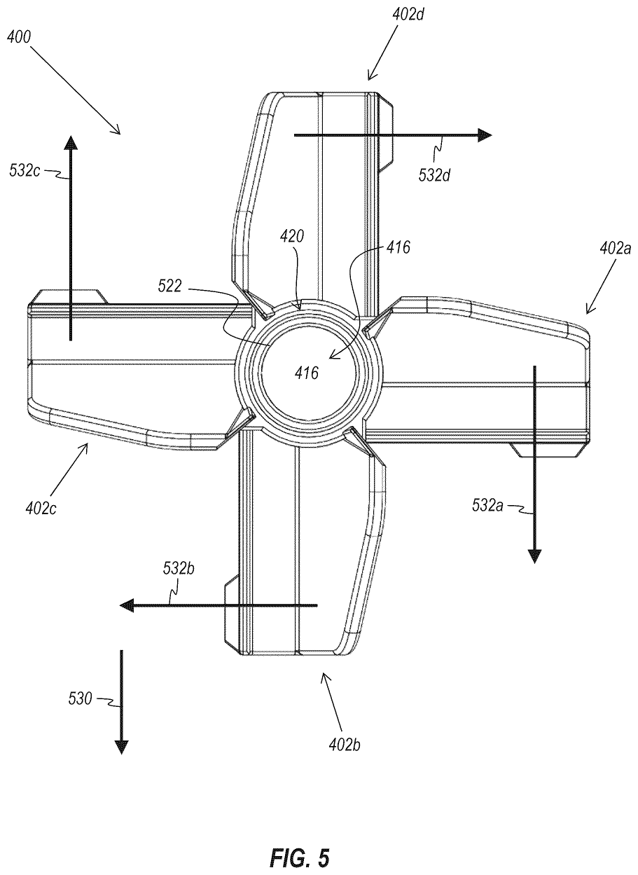

FIG. 5 illustrates a top view of the stand 400, showing the arrangement of the holders 402a, 402b, 402c, and 402d around the perimeter of the receptacle 420. FIG. 5 also illustrates that the receptacle 420 can include a retention lip 522 similar to the retention lip 322 described hereinabove.

In the example shown in FIG. 5, the holders 402a, 402b, 402c, and 402d each face different azimuthal directions (or are configured to hold devices such that displays of the devices face different azimuthal directions). For instance, FIG. 5 illustrates a reference direction 530, an azimuthal direction 532a for holder 402a (with an azimuth angle of 0°), an azimuthal direction 532b for holder 402b (with an azimuth angle of 90°), an azimuthal direction 532c for holder 402c (with an azimuth angle of 180°), and an azimuthal direction 532d for holder 402d (with an azimuth angle of 270°). FIG. 5 furthermore depicts that, in some implementations, the holders 402a, 402b, 402c, and 402d of a stand 400 can be rotationally symmetric with respect to a vertical or central axis (e.g., extending through the receptacle opening 416). The order of rotational symmetry can correspond to the quantity of holders present in the mobile electronic device stand. For instance, for the stand 400 with four holders, the holders 402a, 402b, 402c, and 402d can exhibit rotational symmetry of the fourth order (or four-fold rotational symmetry, where the stand looks substantially the same after being rotated by 90 degrees, 180 degrees, 270 degrees, and 360 degrees around its central or vertical axis). Such a configuration of a mobile electronic device stand can be adapted for multi-person seating arrangements where multiple individuals sit around a table facing inward.

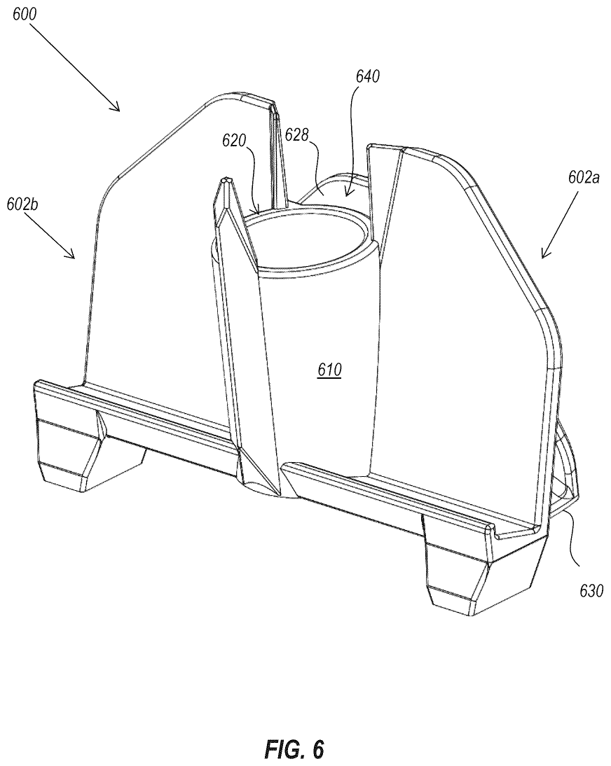

In some instances, a mobile electronic device stand may be used in restaurants, coffee shops, or other businesses that place paper menus, advertisements, or other printed materials at tables for review by customers. A mobile electronic device stand may be configured to provide an organization system for such printed materials in addition to or in place of a receptacle as described above. For example, FIG. 6 illustrates an embodiment of a mobile electronic device stand 600 that includes two holders 602a and 602b that face the same azimuthal direction (or that are arranged to cause displays of electronic devices placed therein to face the same azimuthal direction).

In the example shown in FIG. 6, the stand 600 includes a slot 640 that is defined by a slot wall 628 and a slot base 630 so that the lateral sides of the slot 640 remain open. In alternative configurations, a sidewall is present at one or more lateral ends of the slot 640. In some implementations, the slot base 630 can be implemented as a planar surface that is substantially parallel to the substantially horizontal surface the stand 600 is placed on.

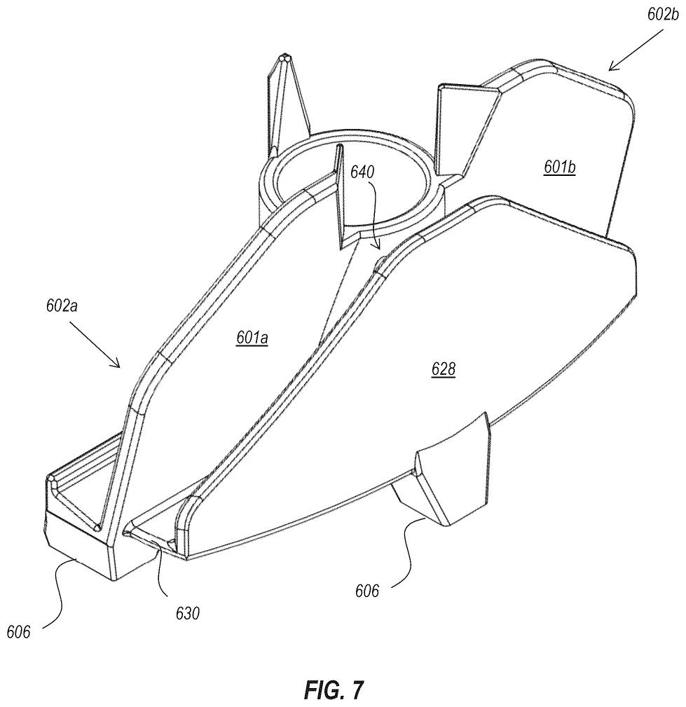

FIG. 7 illustrates another view of the stand 600 that depicts the slot 640 defined by the slot wall 628 and the slot base 630. The slot 640 can be additionally defined by the rear supports 601a and 601b of the holders 602a and 602b. FIG. 7 furthermore illustrates that the slot base 630 and/or the slot wall 628 can be connected to or extend from a part of the base 606 of the overall stand 600.

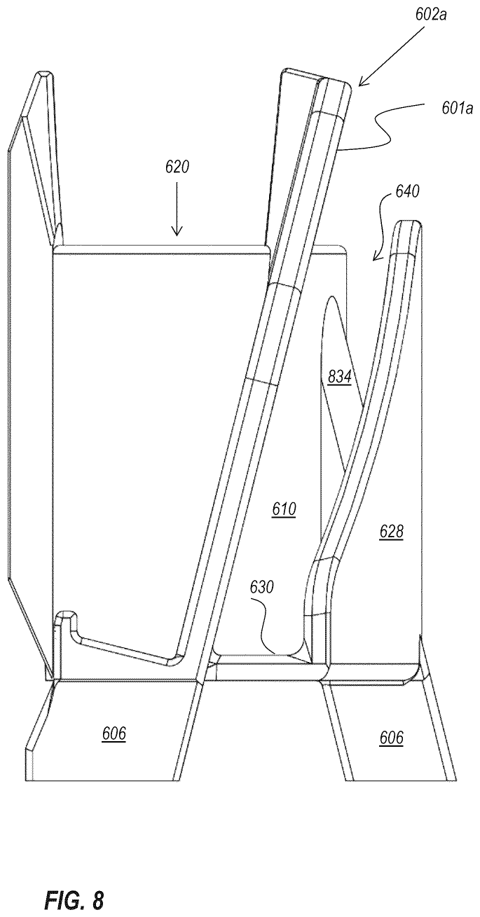

FIG. 8 illustrates a side view of the stand 600 and also depicts the slot 640 defined by slot wall 628, the slot base 630, and the rear supports 601a and 601b of the holders 602a and 602b. FIG. 8 demonstrates that the slot 640 can be further defined by a receptacle sidewall 610 of a receptacle 620 of the stand 600. Additionally, or alternatively, the slot 640 can be at least partially defined by a buttress 834 that extends from the receptacle 620 toward the part of the base 606 that supports the slot base 630 and/or the slot wall 628.

In the example shown in FIGS. 6 through 8, the slot wall 628 (and therefore the slot 640) has a generally arcuate shape that has the same direction of curvature as part of the receptacle sidewall 610. However, this configuration is provided by way of example only, and other variations are possible. For instance, a slot wall of a mobile electronic device stand can have a planar or other shape. Furthermore, although the slot wall 628 is depicted as having a unitary, continuous structure, a slot wall of a mobile electronic device stand can be composed of multiple members and/or can otherwise have a discontinuous structure (e.g., being formed by a plurality of pegs or other members, by a grid sheet, by parallel bars, and/or other components).

A mobile electronic device stand and any of its components described herein may be formed of any suitable material, including without limitation polymers, wood, metals, composites, and/or others. Although examples provided herein depict and/or describe a mobile electronic device stand as including a receptacle and/or a printed materials slot in addition to multiple device holders, a mobile electronic device stand may comprise additional or alternative features, such as a condiment holder, an interactive display, wireless charging functionality, and/or others.

As another example, a mobile electronic device stand can be configured to receive a battery pack that supplies power to one or more charging ports or charging interfaces. In some instances, the receptacle (e.g., receptacle 120, 420, 620) of the stand is configured to receive and retain the battery pack (e.g., the battery pack can have a cylindrical shape corresponding to the shape of the receptacle). In some instances, the battery pack itself includes one or more charging ports or interfaces arranged on a top thereof, such that the charging ports or interfaces are accessible from the top of the stand when the battery pack is arranged within the receptacle of the stand. The battery pack can be shaped to allow for a centerpiece (e.g., a candle, flower vase/arrangement, etc.) to be placed thereover, thereon, or therein (e.g., within a nested receptacle defined by the battery pack itself) when the battery pack is placed within the receptacle of the stand. In some implementations, the stand includes one or more electrodes or other connection interfaces configured to connect to the battery pack (e.g., when the battery pack is arranged within the receptacle) to allow the battery pack to supply power to one or more charging ports or interfaces arranged on the stand. For instance, one or more rear supports of one or more holders of the stand can include one or more wireless charging coils integrated therein, and the wireless charging coil(s) can be powered by the battery pack when the battery pack connects to the electrodes or other connection interfaces of the stand (e.g., within the receptacle of the stand).

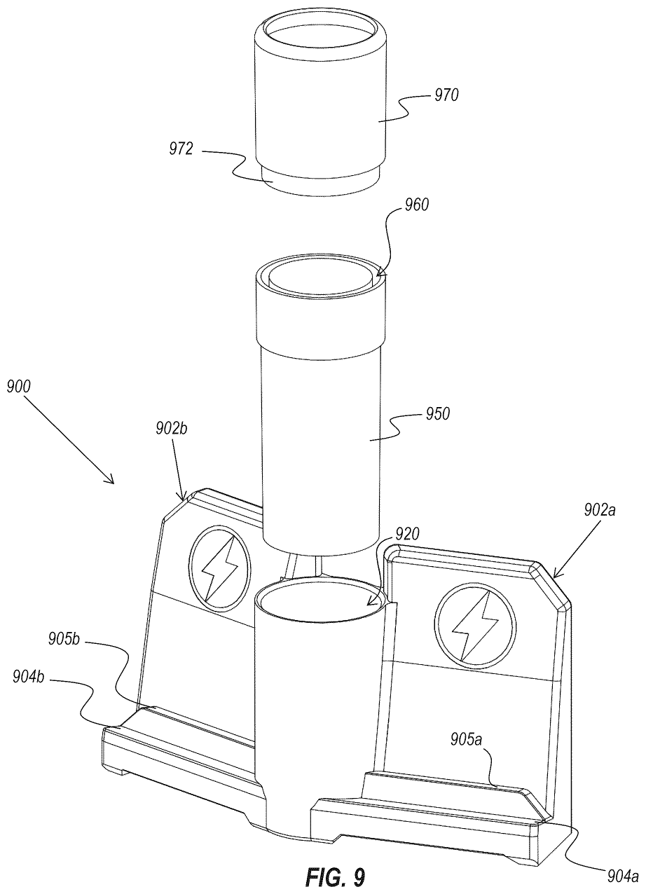

For example, FIG. 9 illustrates another example mobile electronic device stand 900 that is configured to receive and retain a battery pack 950. The battery pack 950 may be sized and shaped for at least partial advancement into the receptacle 920 of the mobile electronic device stand 900. In the example shown in FIG. 9, the battery pack 950 also includes interconnection features (e.g., an annular recess 960) arranged at a top thereof, enabling the battery pack 950 to receive an additional component 970 (e.g., by engaging with corresponding interconnection features of the additional component 970, such as an annular protrusion 972). In the example shown in FIG. 9, the additional component 970 is embodied as an additional receptacle, able to perform various functions described hereinabove in connection with receptacles 120, 420, 620. In some implementations, the additional component 970 includes features powered by battery cells of the battery pack 950, such as lighting features, audio output features, etc. In this regard, the additional component 970 may be in electrical communication with the battery pack 950 (e.g., the two may be integrally formed, or the two may include respective electrode sets configured to contact one another when the additional component 970 engages with the battery pack 950). In one example, the additional component 970 includes a tea light or candle (e.g., an electrical flame) powered by the battery pack 950.

In some embodiments, operation of the electrically powered features of the additional component 970 may be controlled by one or more remote controllers (e.g., a smartphone application, a remote control interface, etc., which may be adapted to control additional components of multiple stands), which may control activation, deactivation, mode switching (e.g., changing in lighting modes, audio selection or output modes, etc.), and/or other operational aspects. Correspondingly, the additional component 970 may include one or more wireless communication components.

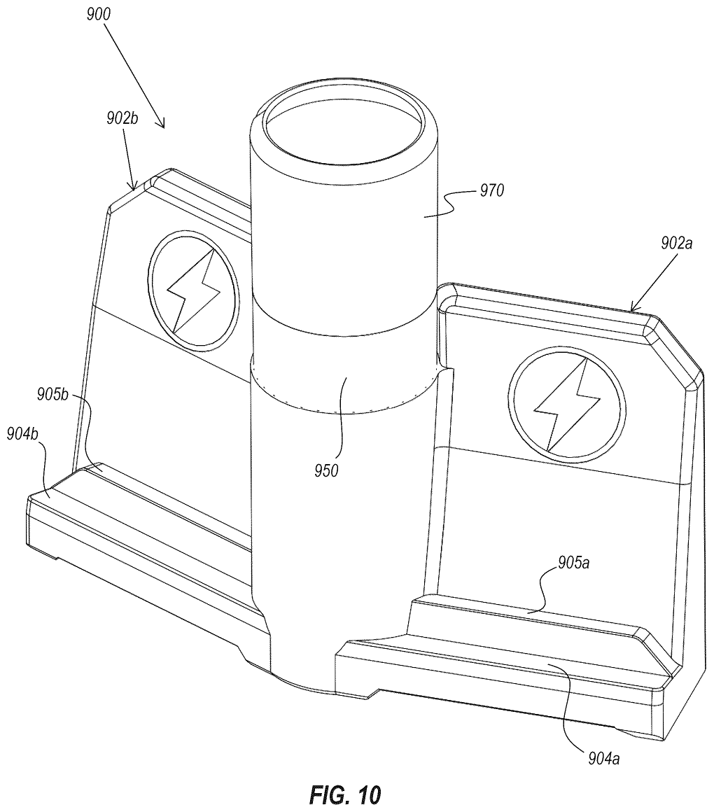

FIG. 10 illustrates the mobile electronic device stand 900 with the battery pack 950 positioned within the receptacle 920 and with the additional component 970 engaged with the battery pack 950 (e.g., via engagement between the annular protrusion 972 and the annular recess 960). The battery pack 950 may house one or more battery cells configured to be charged and discharged. The battery pack 950 may include a plurality of electrodes positioned thereon that can interface with corresponding electrodes on the stand 900 (e.g., arranged within the receptacle 920). For example, when the battery pack 950 is received by the receptacle 920 as shown in FIG. 10, the electrodes of the battery pack 950 and the stand 900 may contact one another, enabling the battery cell(s) of the battery pack 950 to supply power to one or more components of the stand 900, which may enable the component(s) of the stand 900 to charge other devices (e.g., mobile electronic devices of users). For instance, the holders 902a and 902b of the stand 900 as shown in FIGS. 9 and 10 may include one or more respective wireless charging coils (e.g., embedded in or housed by the material forming the rear supports of the holders 902a and 902b). The wireless charging coils may be electrically connected to the electrodes of the stand 900 such that, when the battery pack 950 is connected to the stand 900, the battery pack 950 supplies power to the wireless charging coils to facilitate charging of user devices (e.g., when such devices are retained by the holders 902a and/or 902b).

In some implementations, operation of the charging coils of the stand 900 (and/or additional stands) may be controlled by one or more remote controllers (e.g., a smartphone application, a remote control interface, etc., which may or may not comprise the same controller that operates features of the additional component 970, where implemented). For instance, using a remote controller, an owner of the stand 900 may remotely enable or disable wireless charging functionality for the stand 900 without removing or inserting the battery pack 950 from the receptacle 920 of the stand 900. Correspondingly, the battery pack 950 may include one or more wireless communication components.

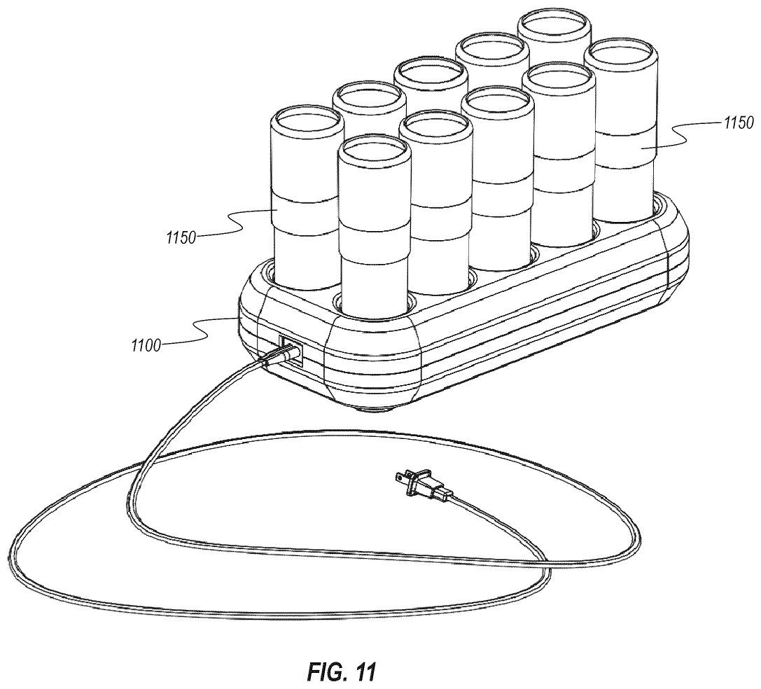

As indicated above, the battery cells of the battery pack 950 may be charged prior to use to power wireless charging and/or other functionality (e.g., features of the additional component 970) associated with the stand 900. FIG. 11 illustrates an example charging device 1100 that may be configured to charge multiple battery packs 1150 for use in conjunction with multiple mobile electronic device stands.

FIGS. 9 and 10 illustrate the holders 902a and 902b as including respective steps 905a and 905b (e.g., to enable differently sized user mobile electronic devices to be wirelessly charged by the charging coils of the holders 902a and/or 902b). For instance, the bottoms of smaller devices may rest atop the steps 905a and 905b (e.g., rather than bottom supports 904a and 904b) to align charging coils of the smaller devices with the charging coils of the holders 902a and 902b. One will appreciate, in view of the present disclosure, that such steps may be omitted in one or more embodiments (e.g., where the charging coils of the holders 902a and 902b cover a sufficient area to accommodate differently sized user devices.

Although examples provided herein depict and/or describe a mobile electronic device stand as a being formed as a unitary structure, one or more components of a mobile electronic device stand may be modular and/or collapsible. For instance, a mobile electronic device stand can include a receptacle with engagement features positioned thereabout that are configured to selectively receive and secure holders, slots, additional receptacles, interactive displays, menu clips/stands/holders, and/or other components that include corresponding engagement features, enabling a mobile electronic device stand to be adapted with different quantities and/or types of holders or other features to suit different needs and/or environments.

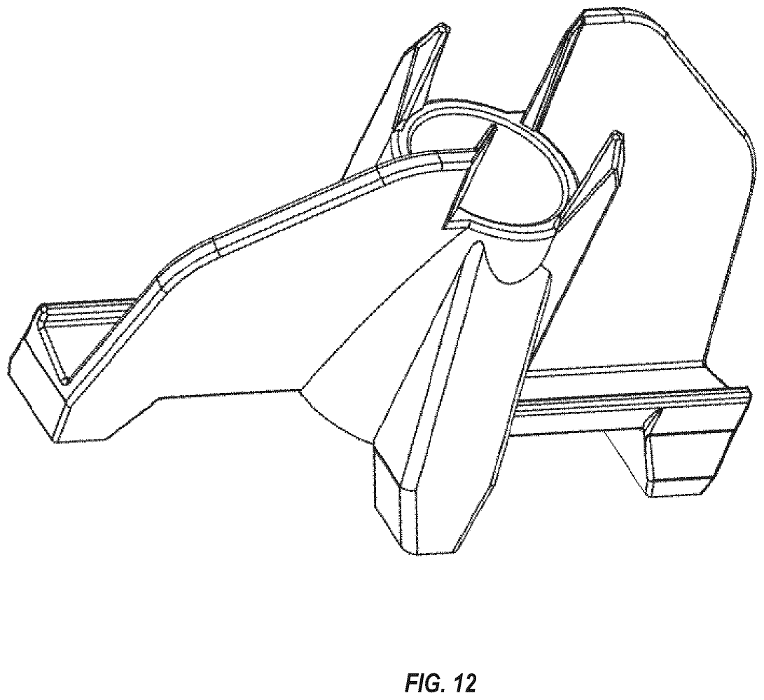

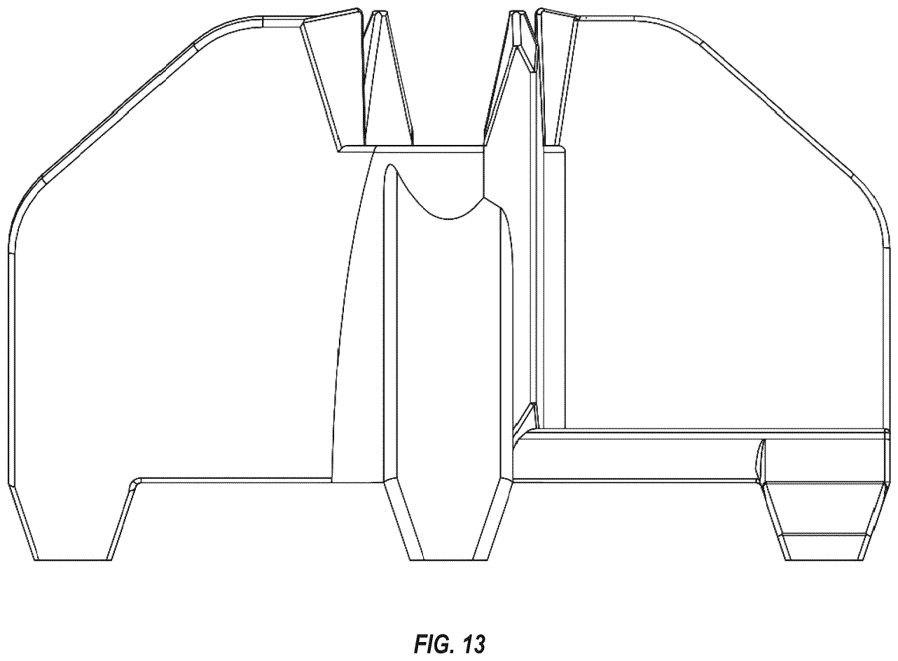

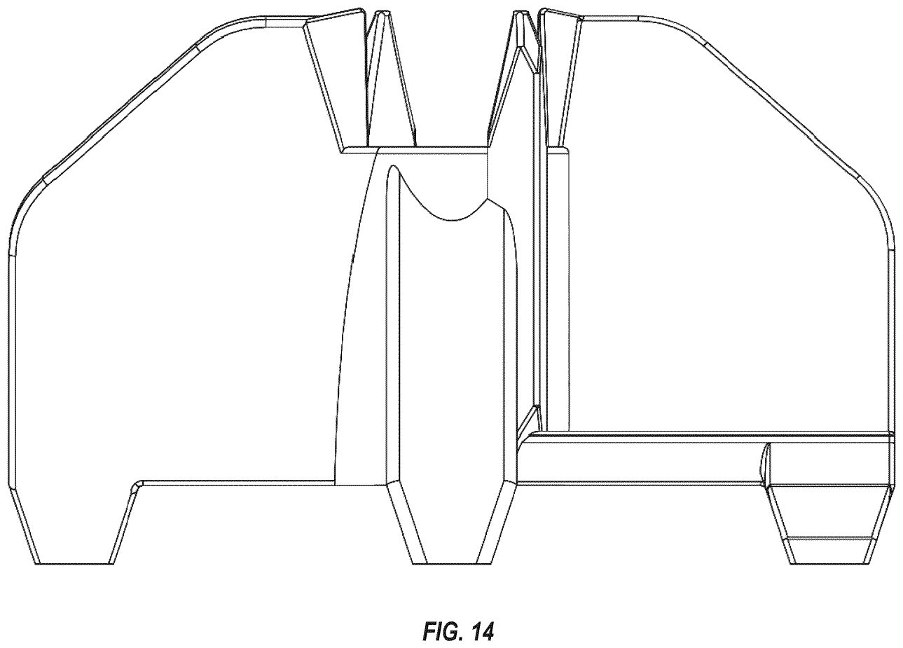

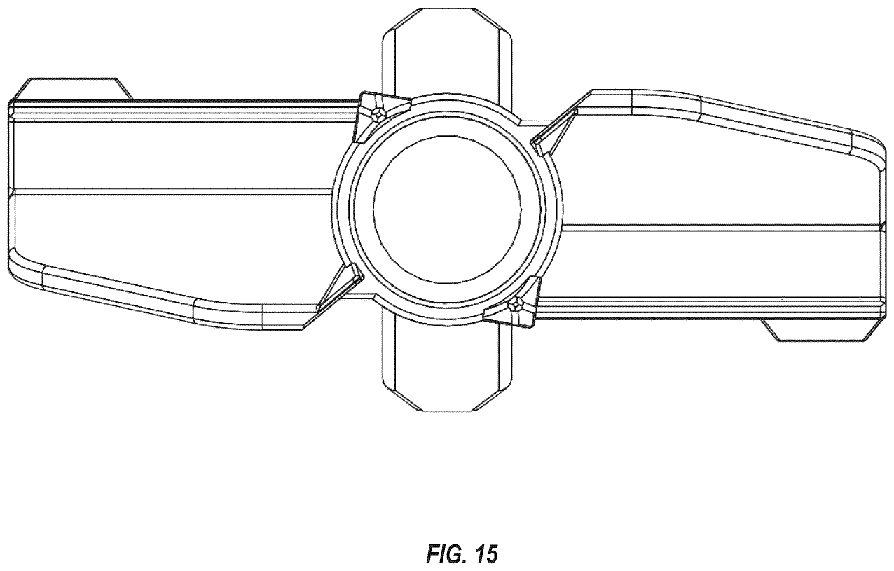

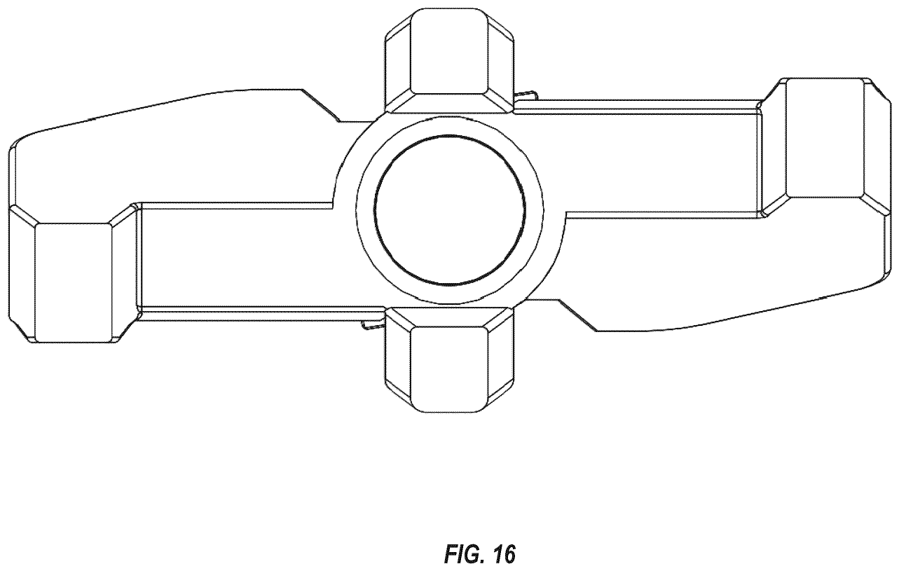

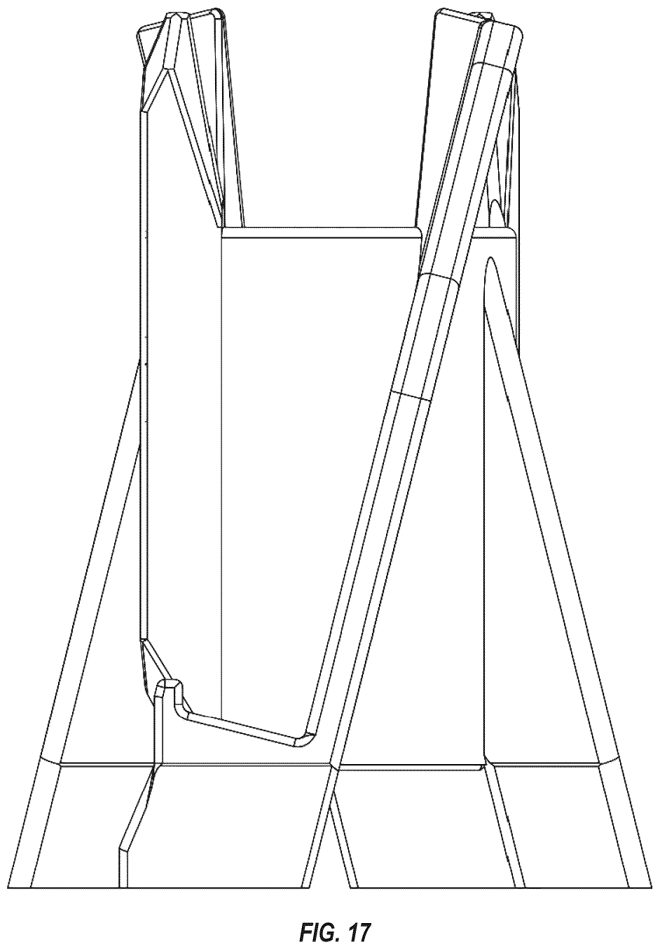

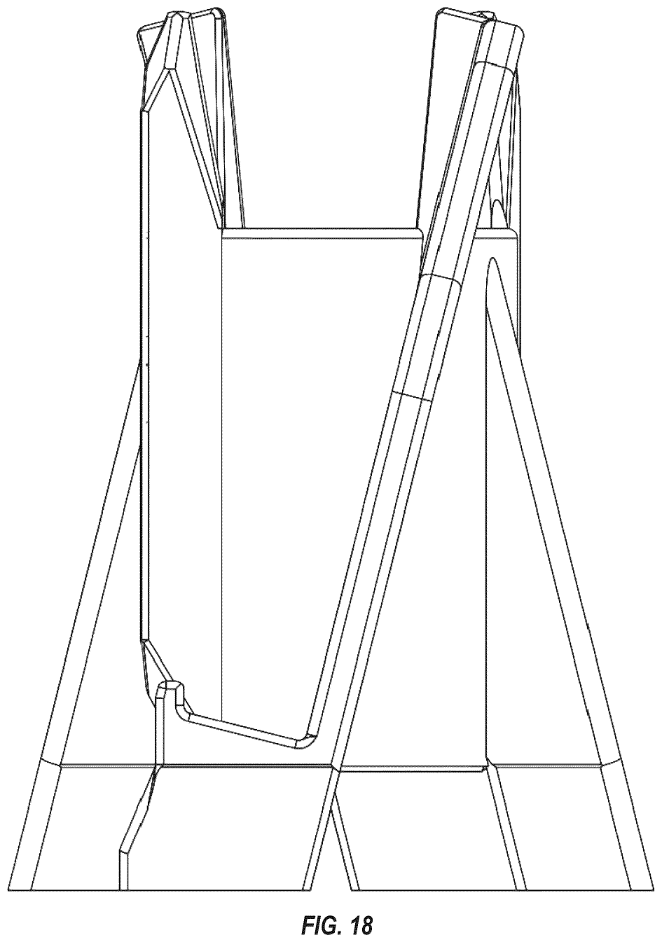

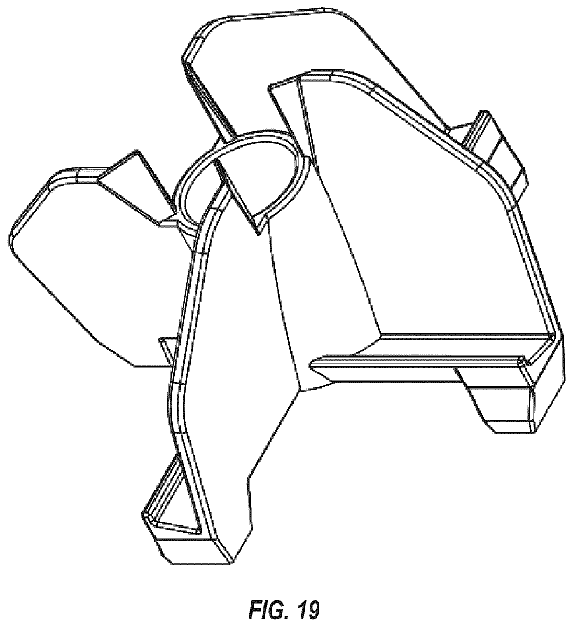

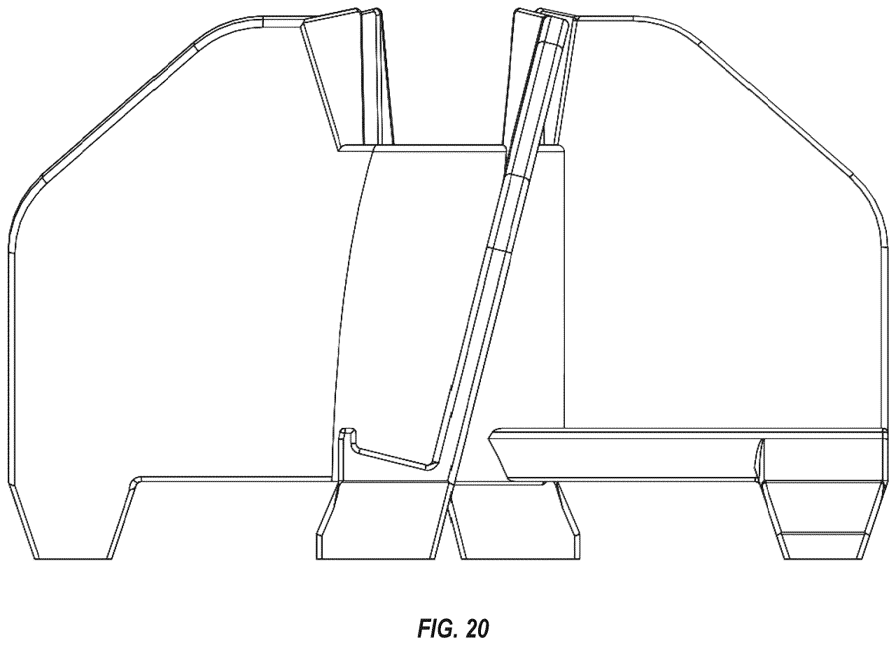

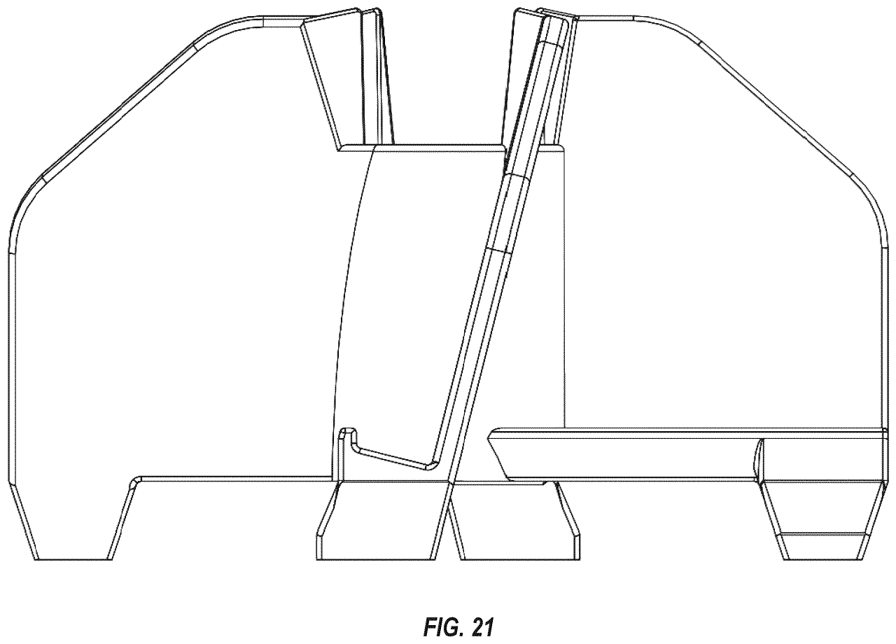

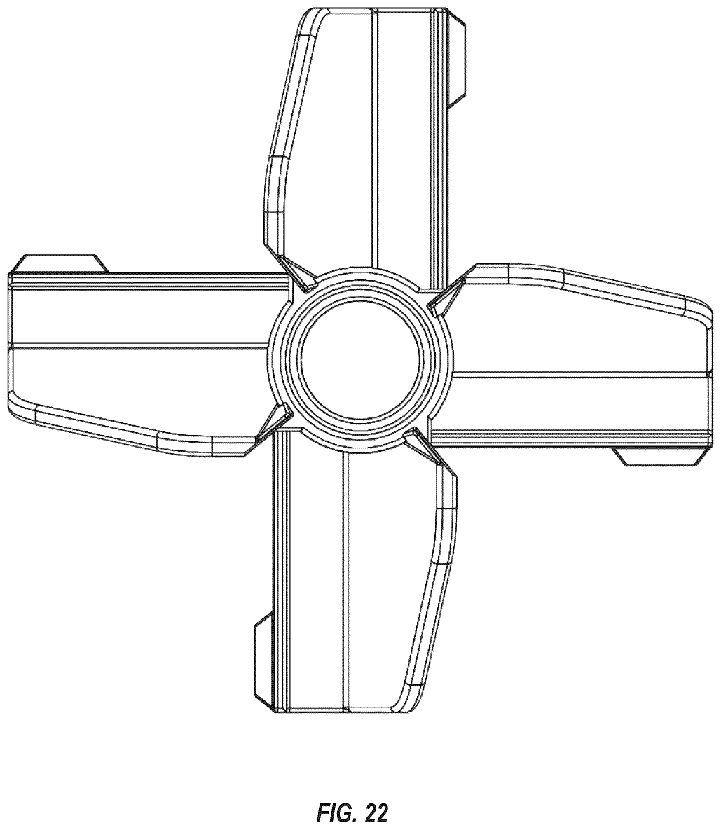

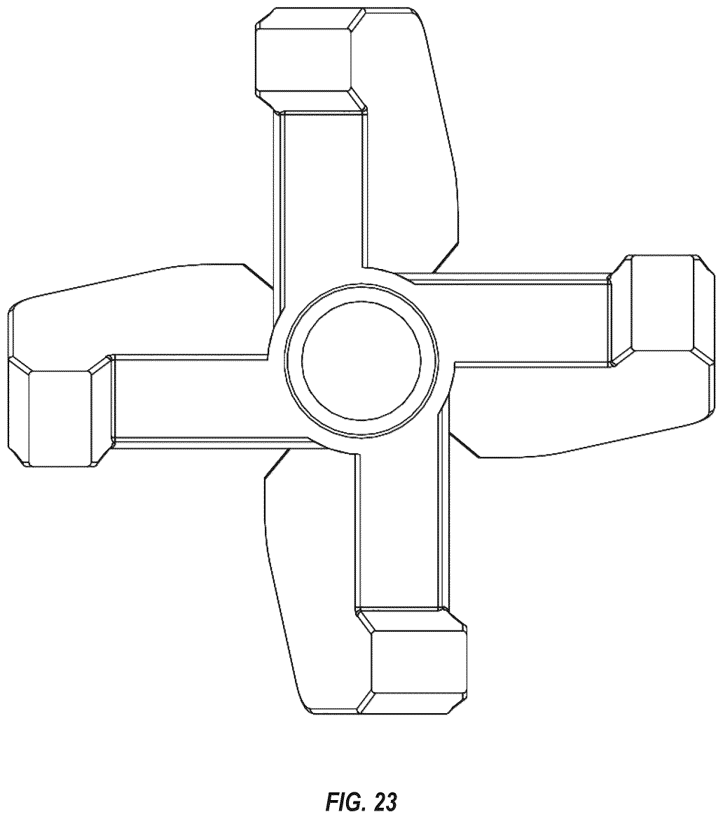

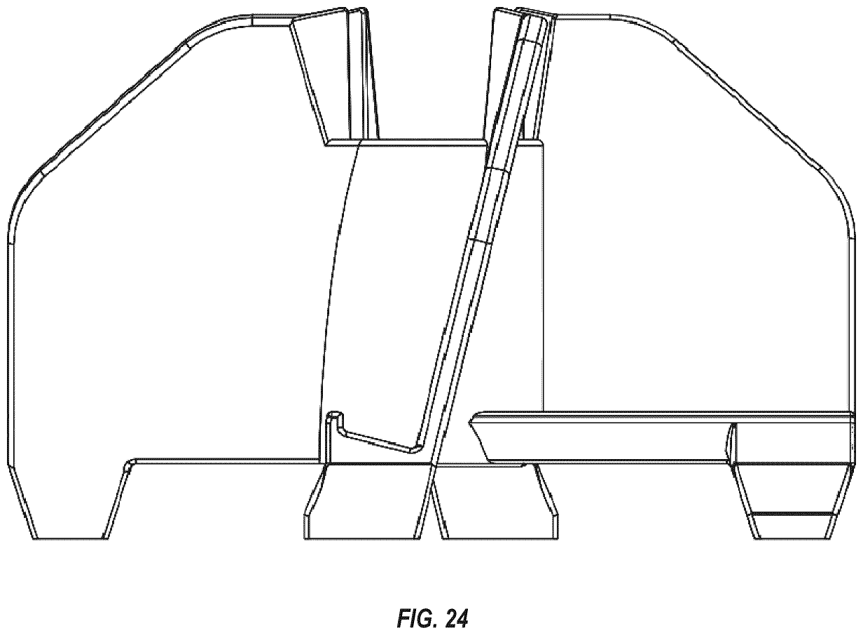

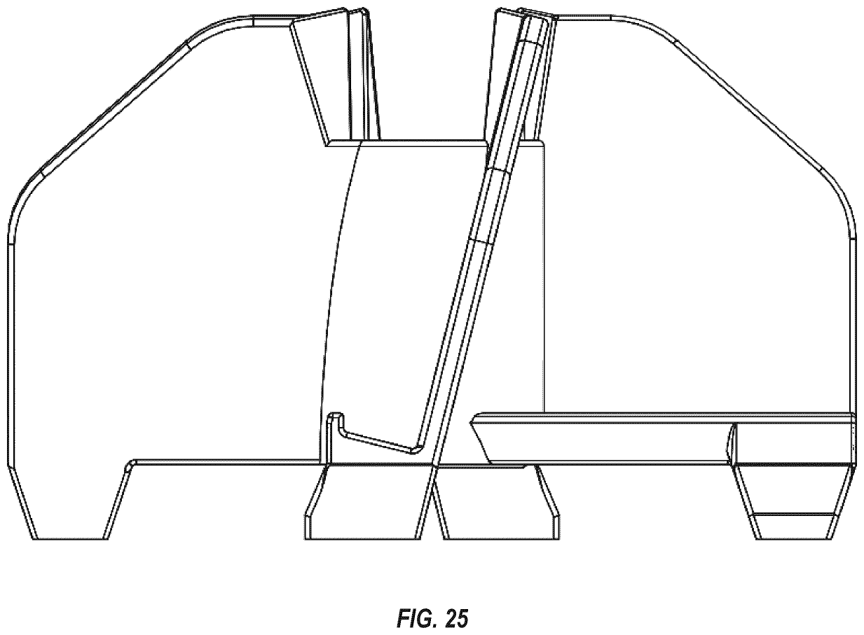

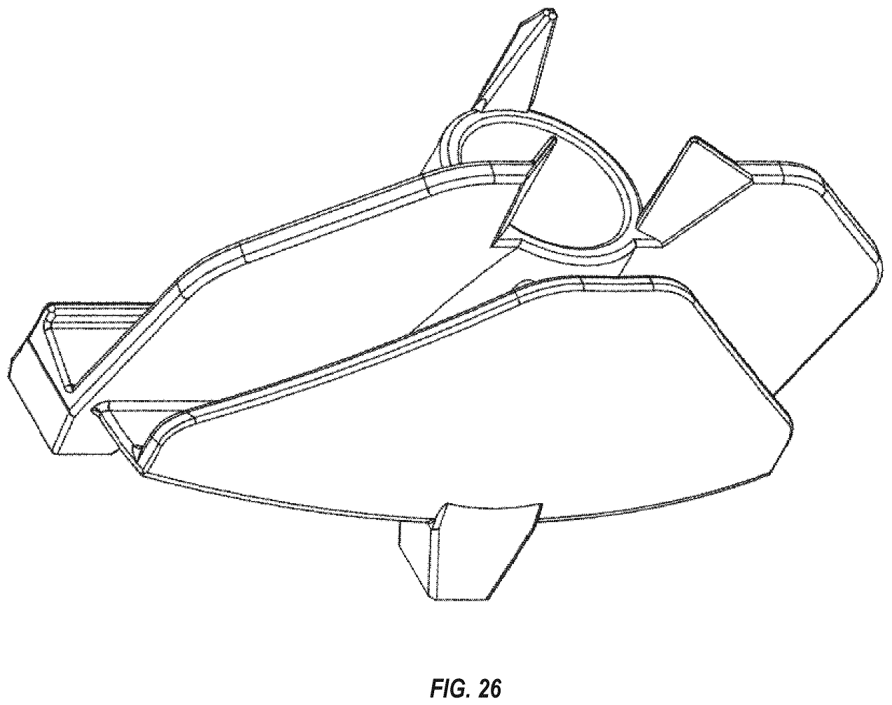

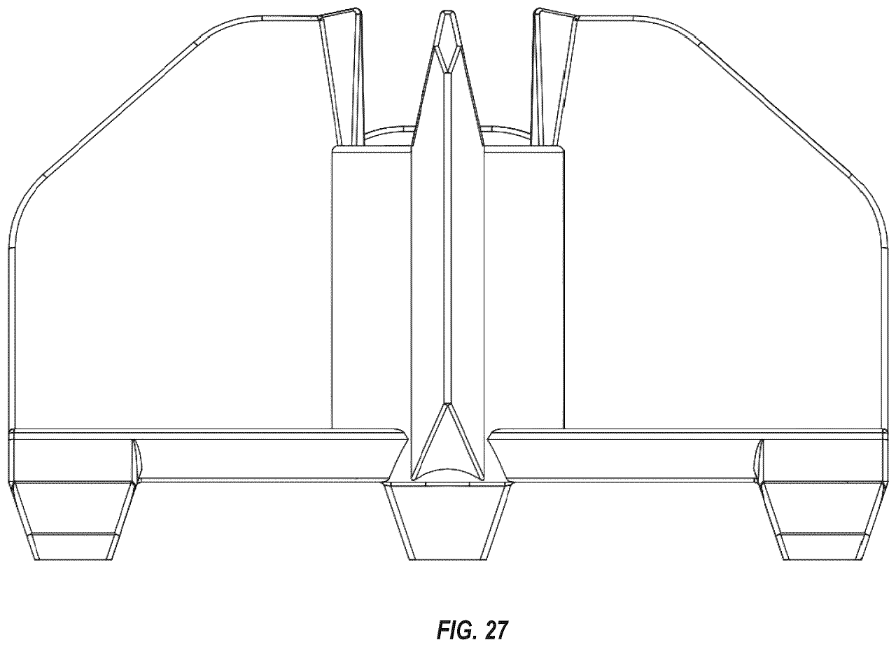

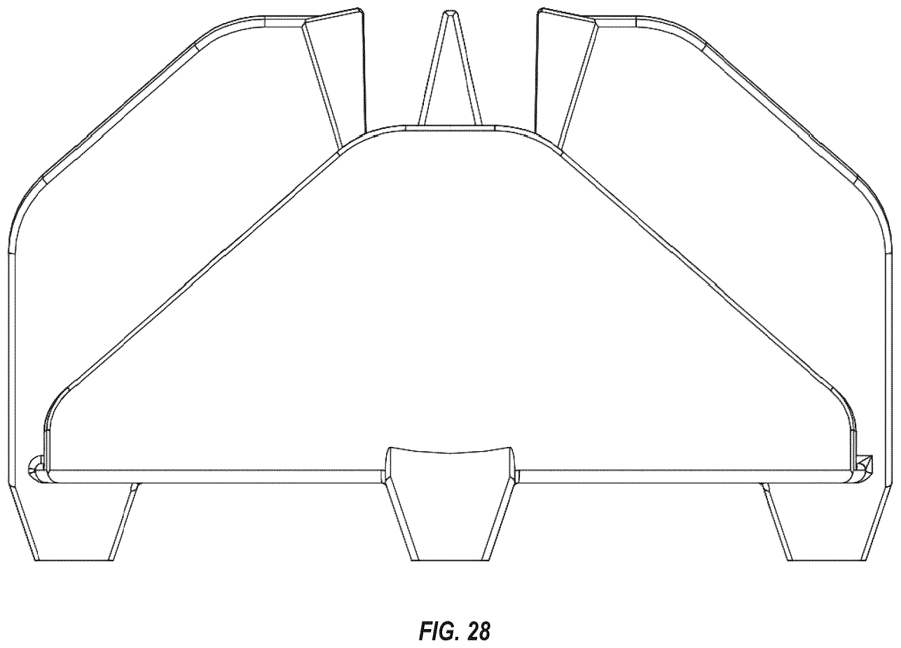

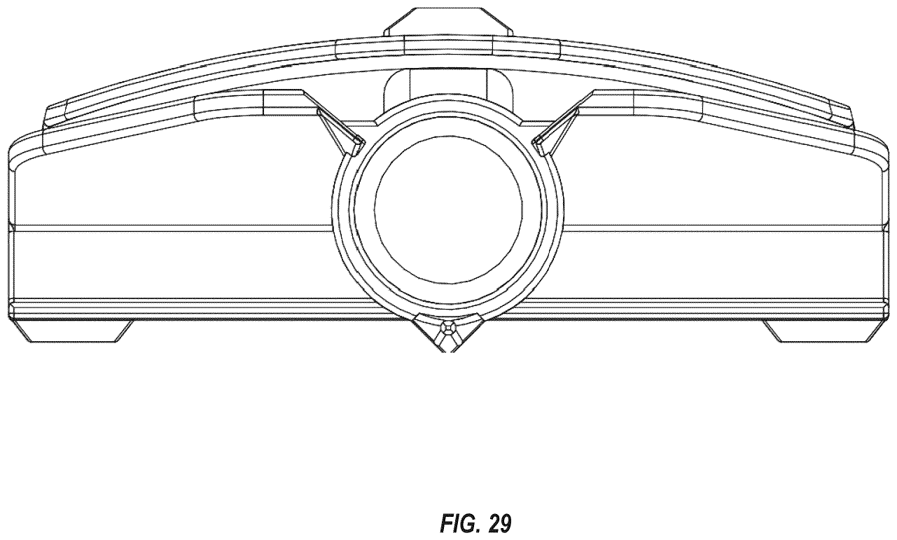

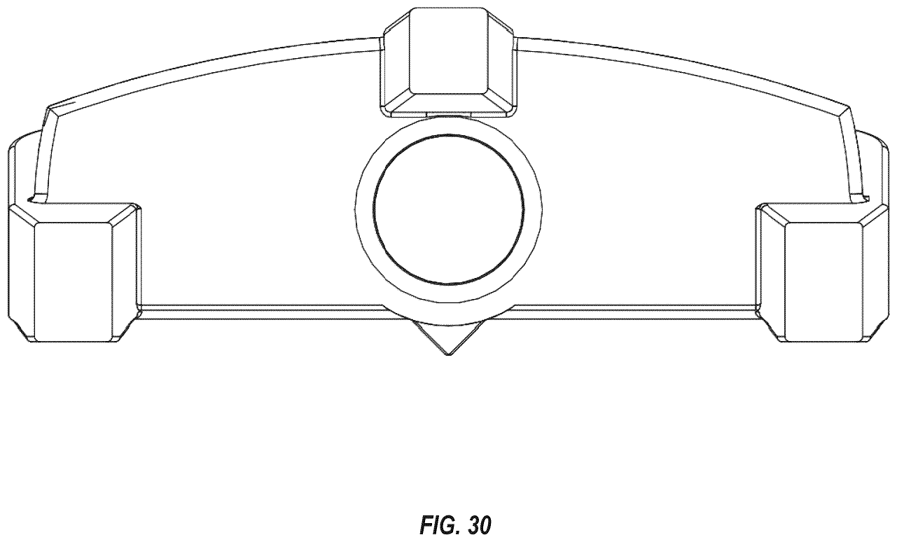

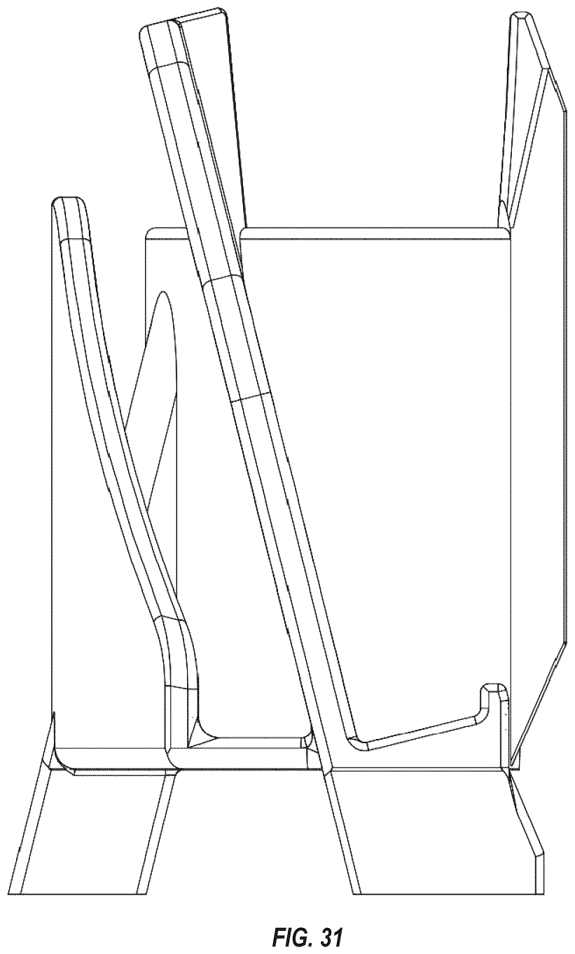

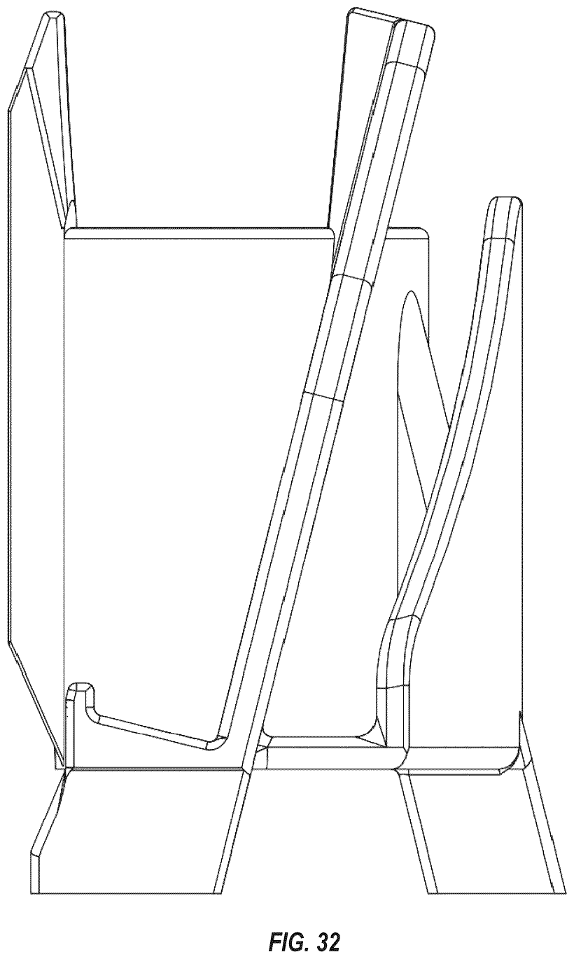

FIGS. 12 through 32 illustrate various views of various embodiments of mobile electronic device stands.

Disclosed embodiments include at least those represented in the following numbered clauses:

Clause 1. An electronic device stand, comprising: a base configured for placement on a substantially horizontal surface; and a plurality of electronic device holders connected to the base, each of the plurality of electronic device holders being configured to receive and support a respective electronic device such that a respective normal vector of a respective display of the respective electronic device is angularly offset from a surface normal vector of the substantially horizontal surface, wherein at least two of the plurality of electronic device holders are configured to support respective electronic devices such that respective electronic displays of the respective electronic devices face at least partially different azimuthal directions when held by the at least two of the plurality of electronic device holders.

Clause 2. The electronic device stand of clause 1, wherein each respective electronic device holder comprises a respective rear support and a respective bottom support.

Clause 3. The electronic device stand of clause 2, wherein each respective electronic device holder of the plurality of electronic device holders further comprises a respective retention lip extending from the respective bottom support.

Clause 4. The electronic device stand of clause 1, wherein the base comprises one or more feet.

Clause 5. The electronic device stand of any one of clauses 1-4, further comprising a receptacle defining an opening, wherein each of the plurality of electronic device holders is arranged radially about the receptacle.

Clause 6. The electronic device stand of clause 5, wherein each of the plurality of electronic device holders is at least partially defined by one or more walls of the receptacle.

Clause 7. The electronic device stand of clause 5 or clause 6, further comprising a slot wall that at least partially defines a slot configured to retain an object, wherein the slot is further defined by a slot base of the electronic device stand, and wherein the slot is open to at least one lateral side of the electronic device stand.

Clause 8. An electronic device stand, comprising: a base configured for placement on a substantially horizontal surface; a plurality of electronic device holders connected to the base, each of the plurality of electronic device holders being configured to receive and support a respective electronic device such that a respective normal vector of a respective display of the respective electronic device is angularly offset from a surface normal vector of the substantially horizontal surface; and a receptacle defining an opening, wherein electronic device holders of the plurality of electronic device holders are arranged radially about the receptacle.

Clause 9. The electronic device stand of clause 8, wherein the receptacle comprises a cylindrical shape.

Clause 10. The electronic device stand of clause 8 or clause 9, wherein the electronic device holders of the plurality of electronic device holders are arranged about the receptacle such that the electronic device holders are rotationally symmetric with respect to a vertical axis extending through the receptacle.

Clause 11. The electronic device stand of clause 10, wherein the electronic device holders are discretely rotationally symmetric with respect to the vertical axis of an order corresponding to a quantity of electronic device holders in the plurality of electronic device holders.

Clause 12. The electronic device stand of any one of clauses 8-11, wherein the electronic device holders of the plurality of electronic device holders are at least partially defined by one or more walls of the receptacle.

Clause 13. The electronic device stand of any one of clause 8-12, wherein an electronic device holder of the plurality of electronic device holders comprises a wireless charging coil, wherein the wireless charging coil is electrically connected to a plurality of electrodes arranged within the receptacle, the receptacle being configured to receive a battery pack such that electrodes of the battery pack connect to the plurality of electrodes to supply power to the wireless charging coil.

Clause 14. An electronic device stand, comprising: a base configured for placement on a substantially horizontal surface; at least one electronic device holder of a plurality of electronic device holders is connected to the base, wherein the at least one electronic device holder is configured to receive and support a respective electronic device such that a respective normal vector of a respective display of the respective electronic device is angularly offset from a surface normal vector of the substantially horizontal surface; and a slot wall that at least partially defines a slot configured to retain an object, wherein the slot is further defined by a slot base of the electronic device stand, and wherein the slot is open to at least one lateral side of the electronic device stand.

Clause 15. The electronic device stand of clause 14, wherein the slot wall extends from the base.

Clause 16. The electronic device stand of clause 14 or clause 15, wherein the slot wall comprises an arcuate shape.

Clause 17. The electronic device stand of any one of clauses 14-16, wherein

the slot is at least partially defined by one or more walls associated with the plurality of electronic device holders.

Clause 18. The electronic device stand of any one of clauses 14-17, wherein the slot base comprises a planar surface that is substantially parallel to the substantially horizontal surface when the base is placed on the substantially horizontal surface.

Clause 19. The electronic device stand of any one of clause 14-18, further comprising a receptacle defining an opening, wherein electronic device holders of the plurality of electronic device holders are arranged radially about the receptacle.

Clause 20. The electronic device stand of clause 19, wherein the slot is at least partially defined by one or more wall of the receptacle.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

What is claimed is:

1. An electronic device stand, comprising:
a base configured for placement on a substantially horizontal surface; and
a plurality of electronic device holders connected to the base, each of the plurality of electronic device holders being configured to receive and support a respective electronic device such that a respective normal vector of a respective display of the respective electronic device is angularly offset from a surface normal vector of the substantially horizontal surface, wherein at least two of the plurality of electronic device holders are configured to support respective electronic devices such that respective electronic displays of the respective electronic devices face at least partially different azimuthal directions when held by the at least two of the plurality of electronic device holders.

2. The electronic device stand of claim 1, wherein each respective electronic device holder comprises a respective rear support and a respective bottom support.

3. The electronic device stand of claim 2, wherein each respective electronic device holder of the plurality of electronic device holders further comprises a respective retention lip extending from the respective bottom support.

4. The electronic device stand of claim 1, wherein the base comprises one or more feet.

5. The electronic device stand of claim 1, further comprising a receptacle defining an opening, wherein each of the plurality of electronic device holders is arranged radially about the receptacle.

6. The electronic device stand of claim 5, wherein each of the plurality of electronic device holders is at least partially defined by one or more walls of the receptacle.

7. The electronic device stand of claim 5, further comprising a slot wall that at least partially defines a slot configured to retain an object, wherein the slot is further defined by a slot base of the electronic device stand, and wherein the slot is open to at least one lateral side of the electronic device stand.

8. An electronic device stand, comprising:
a base configured for placement on a substantially horizontal surface;
a plurality of electronic device holders connected to the base, each of the plurality of electronic device holders being configured to receive and support a respective electronic device such that a respective normal vector of a respective display of the respective electronic device is angularly offset from a surface normal vector of the substantially horizontal surface; and
a receptacle defining an opening, wherein electronic device holders of the plurality of electronic device holders are arranged radially about the receptacle.

9. The electronic device stand of claim 8, wherein the receptacle comprises a cylindrical shape.

10. The electronic device stand of claim 8, wherein the electronic device holders of the plurality of electronic device holders are arranged about the receptacle such that the electronic device holders are rotationally symmetric with respect to a vertical axis extending through the receptacle.

11. The electronic device stand of claim 10, wherein the electronic device holders are discretely rotationally symmetric with respect to the vertical axis of an order corresponding to a quantity of electronic device holders in the plurality of electronic device holders.

12. The electronic device stand of claim 8, wherein the electronic device holders of the plurality of electronic device holders are at least partially defined by one or more walls of the receptacle.

13. The electronic device stand of claim 8, wherein an electronic device holder of the plurality of electronic device holders comprises a wireless charging coil, wherein the wireless charging coil is electrically connected to a plurality of electrodes arranged within the receptacle, the receptacle being configured to receive a battery pack such that electrodes of the battery pack connect to the plurality of electrodes to supply power to the wireless charging coil.

14. An electronic device stand, comprising:
a base configured for placement on a substantially horizontal surface;
at least one electronic device holder of a plurality of electronic device holders is connected to the base, wherein the at least one electronic device holder is configured to receive and support a respective electronic device such that a respective normal vector of a respective display of the respective electronic device is angularly offset from a surface normal vector of the substantially horizontal surface; and
a slot wall that at least partially defines a slot configured to retain an object, wherein the slot is further defined by a slot base of the electronic device stand, and wherein the slot is open to at least one lateral side of the electronic device stand.

15. The electronic device stand of claim 14, wherein the slot wall extends from the base.

16. The electronic device stand of claim 14, wherein the slot wall comprises an arcuate shape.

17. The electronic device stand of claim 14, wherein the slot is at least partially defined by one or more walls associated with the plurality of electronic device holders.

18. The electronic device stand of claim 14, wherein the slot base comprises a planar surface that is substantially parallel to the substantially horizontal surface when the base is placed on the substantially horizontal surface.

19. The electronic device stand of claim 14, further comprising a receptacle defining an opening, wherein electronic device holders of the plurality of electronic device holders are arranged radially about the receptacle.

20. The electronic device stand of claim 19, wherein the slot is at least partially defined by one or more wall of the receptacle.
